(19) United States
(12) Patent Application Publication
(10) Pub. No.: US 2013/0330101 A1
(43) Pub. Date: Dec. 12, 2013

(54) Device and Method For Modifying Device Housing

(71) Applicants: Jesus Gonzalez, Chatsworth, CA (US); Gerardo Ortiz, Reseda, CA (US)

(72) Inventors: Jesus Gonzalez, Chatsworth, CA (US); Gerardo Ortiz, Reseda, CA (US)

(21) Appl. No.: 13/491,154

(22) Filed: Jun. 7, 2012

(51) Int. Cl. G03G 15/00

(52) U.S. Cl. 399/109

(57) ABSTRACT

A method presently disclosed provides a first portion of a housing containing at least one protrusion, removes at least a portion of the at least one protrusion, and couples a first material with a second portion of the housing.

### FIELD

The present invention relates generally to the field of toner cartridges.

### BACKGROUND

FIG. 1 depicts an image forming apparatus 100 know in the art. The image forming apparatus 100 may be color and/or black-and-white copiers, color and/or black-and-white printers, and/or so-called “all-in-one devices” that incorporate two or more functions such as scanning, copying, printing, and faxing capabilities in one device.

The image forming apparatus 100 is configured to accept replaceable printer cartridge 10 containing toner for generating images. As known in the art, the printer cartridge 10 comprise one or more guide keys/protrusions 20 configured to be inserted in to one or more guide channels 30 within the image forming apparatus 100.

As known in the art, when image forming apparatus manufacturer designs/updates/manufactures a new model image forming apparatus, they may change the location, width, and/or depth of the guide channels 30. These types of changes to the image forming apparatus may force cartridge manufacturers to change location and/or shape of the guide keys/protrusions 20 to accommodate the changes made to the channels 30. This redesign prevents users from using their unused cartridges in the new image forming apparatus. Similarly, any remanufactured cartridge configured to be used with the old image forming apparatus would have to be discarded because it could not be accommodated by the redesigned image forming apparatus.

To avoid waist and pollution, a need exist for a process and associated apparatus to allow cartridges originally designed for one image forming apparatus to be used by another image forming apparatus.

### SUMMARY

According to a first aspect of the present disclosure, a method is disclosed, the method comprising: providing a first portion of a housing comprising at least one protrusion; removing at least a portion of the at least one protrusion; and coupling a first material with a second portion of the housing.

According to a second aspect of the present disclosure, a method is disclosed, the method comprising: providing a housing for a toner cartridge configured to accommodate a first image forming apparatus; removing at least a portion of the housing, and coupling a first material with the housing to allow the toner cartridge to accommodate a second image forming apparatus.

According to a third aspect of the present disclosure, a housing is disclosed, the housing comprising: a portion of a first protrusion configured to accommodate a first image forming apparatus; and a second protrusion configured to accommodate a second image forming apparatus.

### BRIEF DESCRIPTION OF THE FIGURES

FIG. 1 depicts an image forming apparatus as known in the prior art.

FIG. 2 depicts another image forming apparatus as known in the prior art.

FIG. 3 depicts the image forming apparatus shown in FIG. 2 with modified channels.

FIG. 4 depicts the image forming apparatus shown in FIG. 3 and modified toner cartridge according to the present disclosure.

FIG. 5 depicts the image forming apparatus shown in FIG. 3 and modified toner cartridge according to the present disclosure.

FIG. 6 depicts the image forming apparatus shown in FIG. 3 and modified toner cartridge according to the present disclosure.

FIG. 7 depicts the image forming apparatus shown in FIG. 3 and modified toner cartridge according to the present disclosure.

FIG. 8 depicts a portion of a toner cartridge as known in the prior art.

FIGS. 9-10 depict modified portion of a toner cartridge according to the present disclosure.

FIGS. 11-14 depict a device according to the present disclosure.

FIGS. 15-18 depict another device according to the present disclosure.

FIGS. 19-20 depict another image forming apparatus as known in the prior art.

FIGS. 21-22 depict the image forming apparatus shown in FIG. 20 with modified keying features.

FIGS. 23-24 depict the image forming apparatus shown in FIG. 21 and modified print cartridge according to the present disclosure.

FIGS. 25-26 depict the image forming apparatus shown in FIG. 22 and modified print cartridge according to the present disclosure.

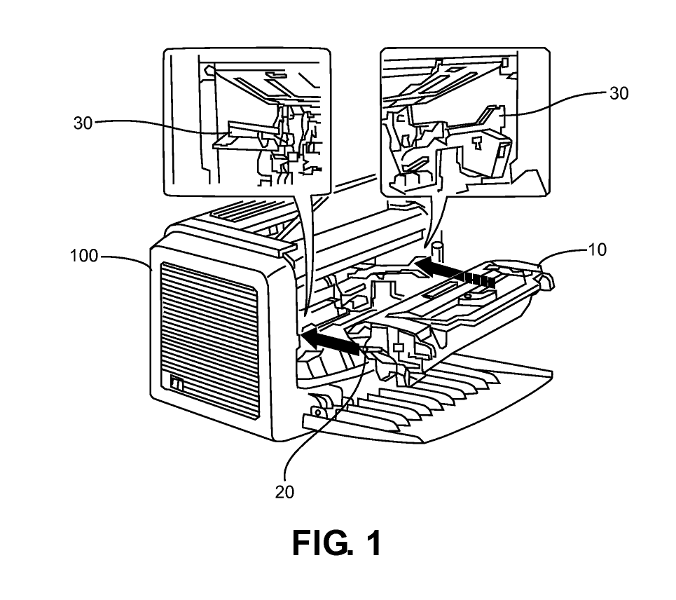

In the following description, like reference numbers are used to identify like elements. Furthermore, the drawings are intended to illustrate major features of exemplary embodiments in a diagrammatic manner. The drawings are not intended to depict every feature of every implementation nor relative dimensions of the depicted elements, and are not drawn to scale.

### DETAILED DESCRIPTION

In the following description, numerous specific details are set forth to clearly describe various specific embodiments disclosed herein. One skilled in the art, however, will understand that the presently claimed invention may be practiced without all of the specific details discussed below. In other instances, well known features have not been described so as not to obscure the invention.

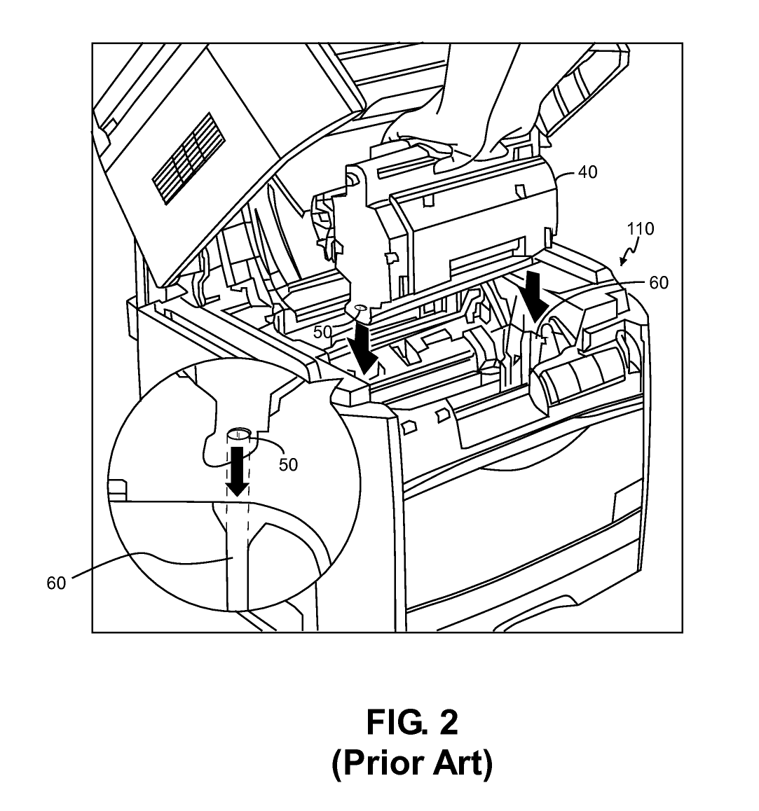

FIG. 2 depicts a toner cartridge 40 known in the art. The toner cartridge 40 may comprise one or more guide keys/protrusions 50 configured to guide the toner cartridge 40 into an image forming apparatus 110 using channels 60. As known in the art, the one or more guide keys/protrusions 50 may be positioned on end caps(s) of the toner cartridge 40 or may be positioned on other outer parts of the housing defining the toner cartridge 40.

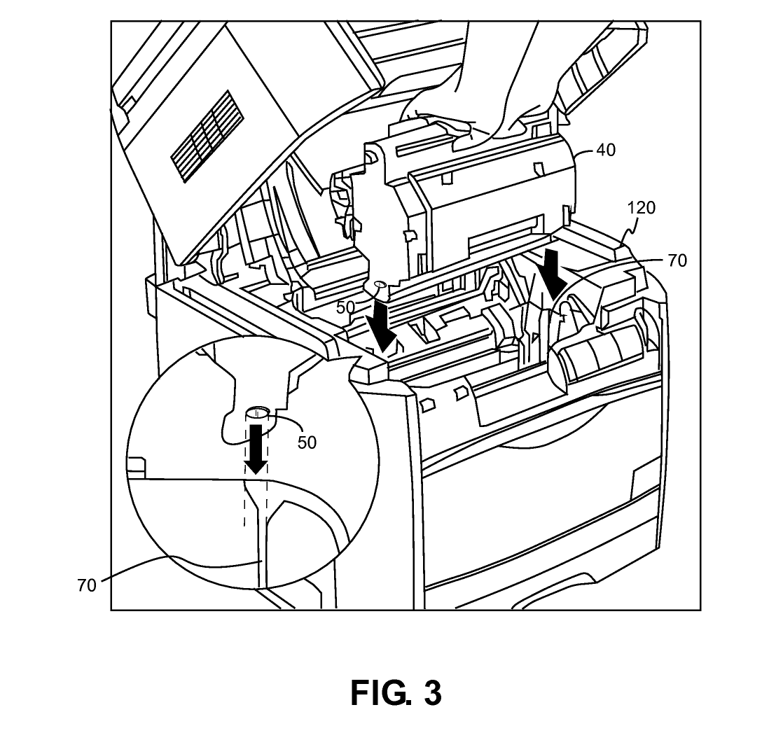

FIG. 3 depicts an image forming apparatus 120 comprising channels 70 that are narrower than the channels 60 of the image forming apparatus 110. If one skilled in the art attempts to install the toner cartridge 40 into the image forming apparatus 120, they would fail because channels 70 cannot accommodate the guide keys/protrusions 50.

In one exemplary embodiment according to the present disclosure, the one or more guide keys/protrusions 50 associated with the toner cartridge 40 may be at least partially removed, replaced, modified and/or moved to another location to allow the toner cartridge 40 to be compatible with the image forming apparatus 120.

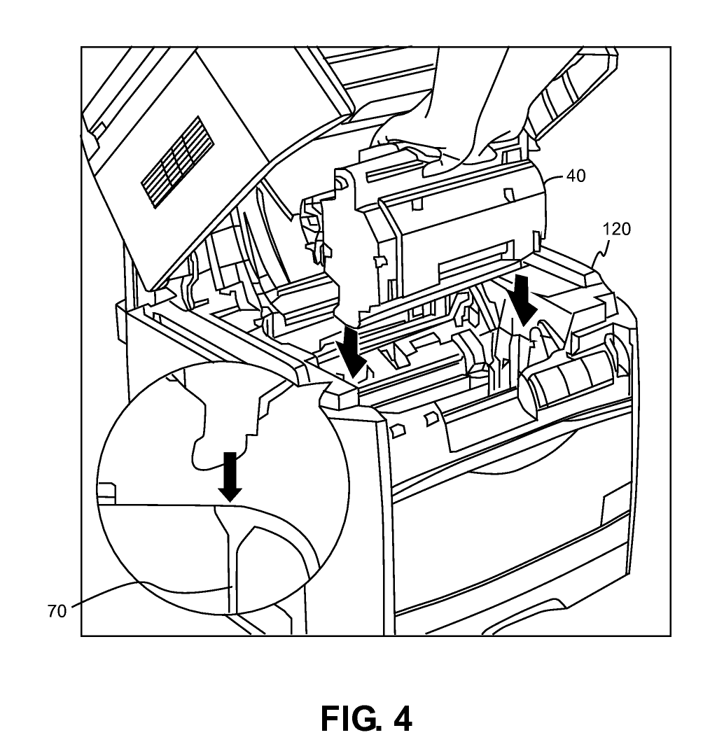

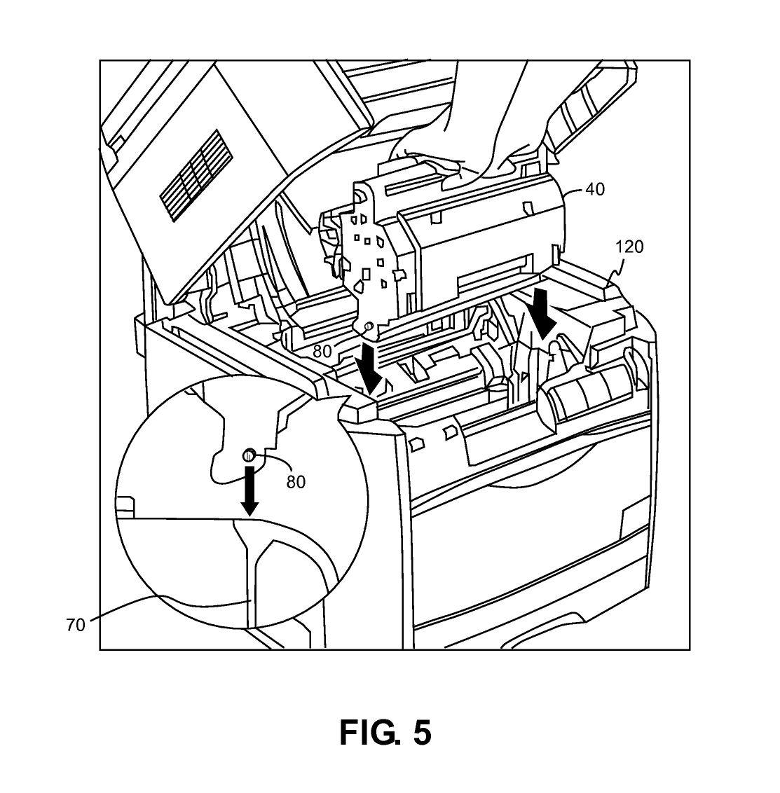

In one exemplary embodiment, the one or more guide keys/protrusions 50 may be completely or partially removed from the toner cartridge 40 as shown in FIG. 4. Although not shown, the removal of the one or more guide keys/protrusions 50 may leave behind an opening/hole (not shown) where the one or more guide keys/protrusions 50 used to be. Once the one or more guide keys/protrusions 50 are removed, new guide keys/protrusions may be provided to allow the toner cartridge 40 to enter the image forming apparatus 120 with channels 70. In one exemplary embodiment, one or more new guide keys/protrusions 80 may be provided to accommodate the channels 70 as shown in FIG. 5. The one or more new guide keys/protrusions 80 may be glued, welded, coupled or fused to a portion of the toner cartridge 40 and aligned with the channels 70. Because the guide keys/protrusions 80 are configured to accommodate the channels 70, the toner cartridge 40 may be utilized/accommodated by the image forming apparatus 120.

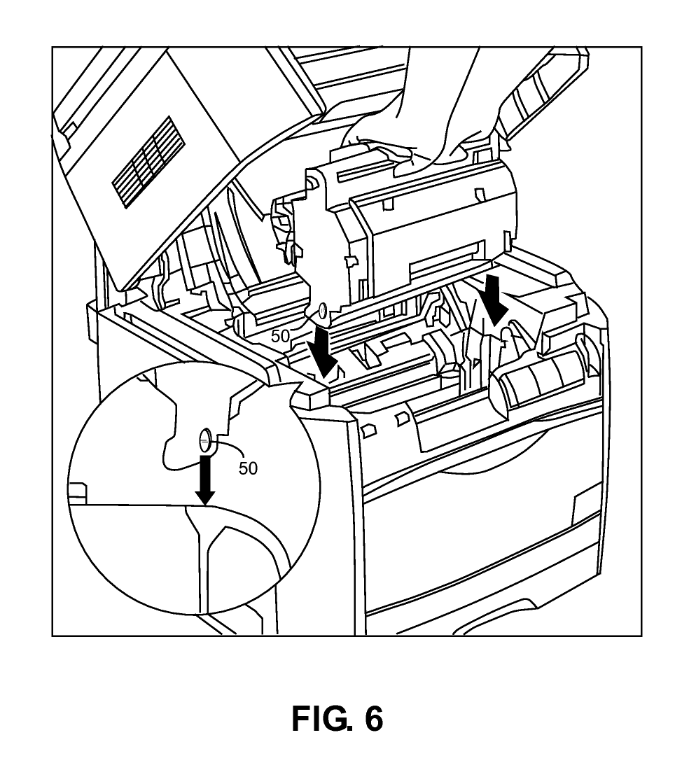

In another exemplary embodiment, the one or more guide keys/protrusions 50 removed from the toner cartridge 40 may be re-used to accommodate the channels 70 as shown in FIG. 6. The one or more guide keys/protrusions 50 may be glued, welded, coupled or fused to a portion of the toner cartridge 40 and aligned with the channels 70. By repositioning and/or aligning the guide keys/protrusions 50, the toner cartridge 40 may be utilized/accommodated by the image forming apparatus 120.

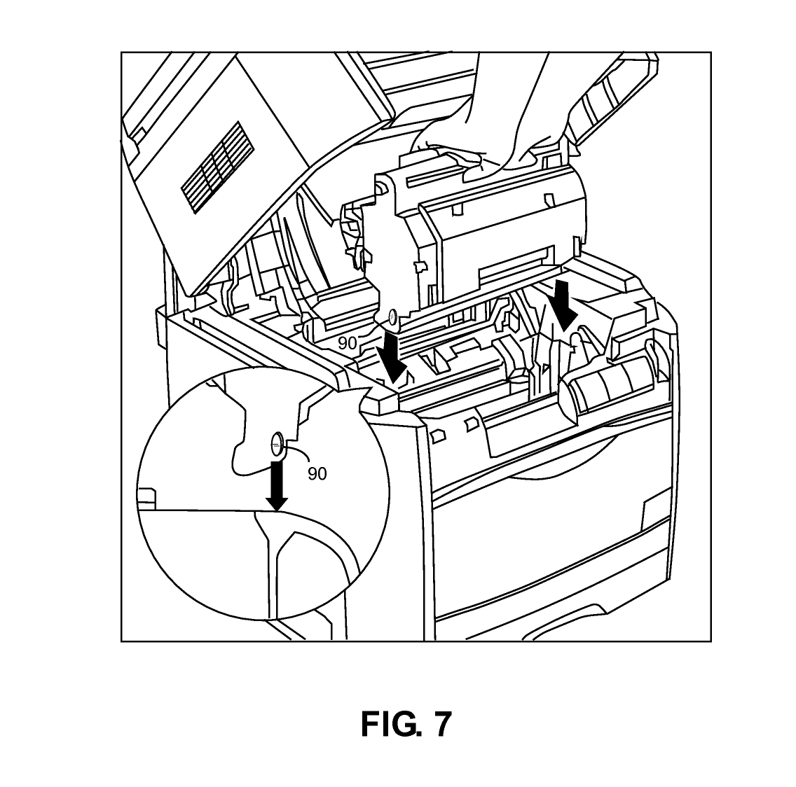

In another exemplary embodiment, one or more new guide keys/protrusions 90 may be provided to accommodate the channels 70 as shown in FIG. 7. The guide keys/protrusions 90 may be substantially similar in shape and/or size to the removed guide keys/protrusions 50. The one or more new guide keys/protrusions 90 may be glued, welded, or fused to a portion of the toner cartridge 40 and aligned with the channels 70. Because the guide keys/protrusions 90 are configured to accommodate the channels 70, the toner cartridge 40 may be utilized/accommodated by the image forming apparatus 120.

Different techniques may be applied to remove at least a portion of the guide keys/protrusions 50. In one exemplary embodiment, at least a portion of the guide keys/protrusions 50 may be removed using a blade and/or a knife. In another exemplary embodiment, at least a portion the guide keys/protrusions 50 may be removed using pliers to break at least a portion the guide keys/protrusions 50 off the toner cartridge 40. In another exemplary embodiment, at least a portion the guide keys/protrusions 50 may be removed using a saw, a laser and/or water-jet.

As known in the art, an image forming apparatus may comprise a detection sensor (not shown) and/or detection circuit (not shown) configured to detect that a toner cartridge has been properly installed in the image forming apparatus. To activate the detection sensor/circuit, the toner cartridges may comprise one or more activation tabs/protrusions (not shown) configured to interact/activate the detection sensor/circuit. As the image forming apparatus is redesigned and/or changed by the manufacturer, the detection sensor/circuit may be repositioned and/or changed. When that occurs, the manufacturers of the toner cartridge may have to re-design the toner cartridges and/or the activation tab to accommodate the new image forming apparatus. As known in the art, the activation tab(s) may be positioned on end caps(s) of the toner cartridge or may be positioned on other outer parts of the housing defining the toner cartridge.

In one exemplary embodiment according to the present disclosure, the one or more activation tabs associated with a particular toner cartridge may be at least partially removed, replaced, and/or moved to another location to accommodate the changes in the image forming apparatus and allow interaction with the detection sensor/circuit.

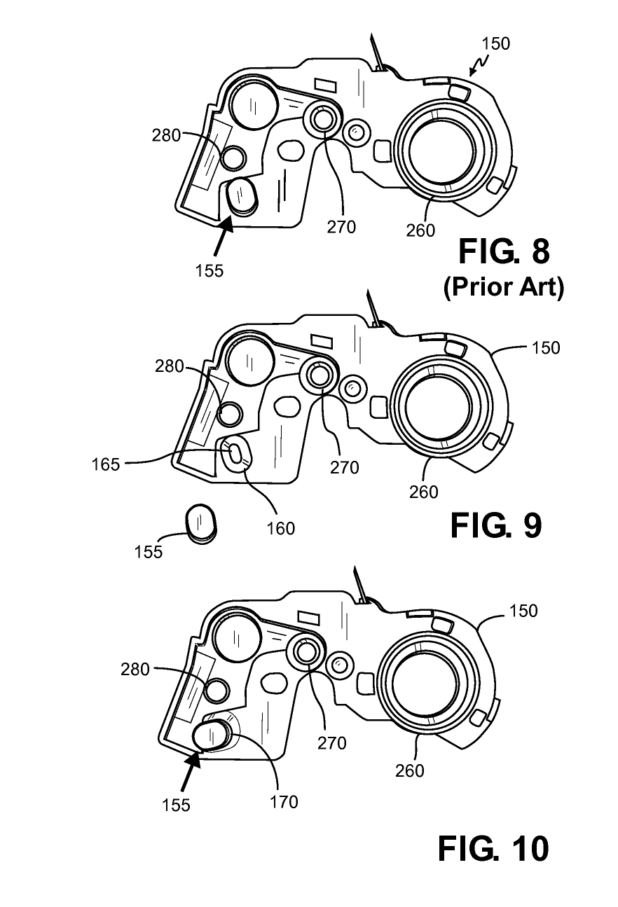

FIG. 8 depicts an end cap 150 known in the art from a toner cartridge (not shown) configured to accommodate an image forming apparatus. The end cap 150 may comprise an activation tab 155. In an exemplary embodiment, the activation tab 155 may be at least partially removed, repositioned, and/or replaced to accommodate another image forming apparatus.

In one exemplary embodiment, at least a portion of the activation tab 155 may be removed from its original position 160 as shown in FIG. 9. In one exemplary embodiment, the removal of the activation tab 155 may leave behind an opening 165. In an exemplary embodiment, the activation tab 155 may be coupled back to the end cap 150 at a position 170 as shown in FIG. 10. The activation tab 155 may be glued, welded, or fused to the end cap 150.

In an exemplary embodiment, the activation tab 155 may be replaced with another activation tab with different outer dimension(s). In another exemplary embodiment, the activation tab 155 may be replaced with another activation tab with similar outer dimension(s).

Different techniques may be applied to remove at least a portion of the activation tab 155. In one exemplary embodiment, at least a portion of the activation tab 155 may be removed using a blade and/or a knife. In another exemplary embodiment, at least a portion the activation tab 155 may be removed using pliers to break at least a portion the activation tab 155 off the end cap 150. In another exemplary embodiment, at least a portion the activation tab 155 may be removed using a saw, a laser and/or water-jet.

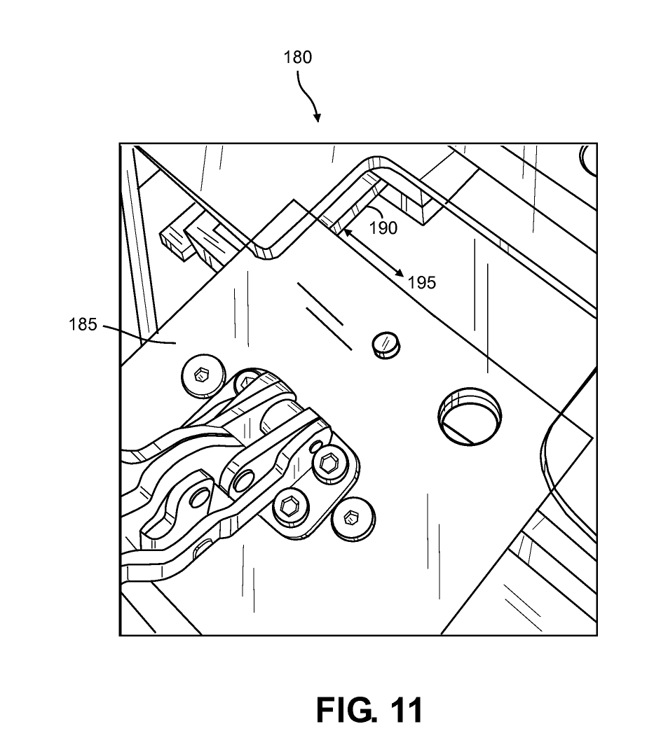

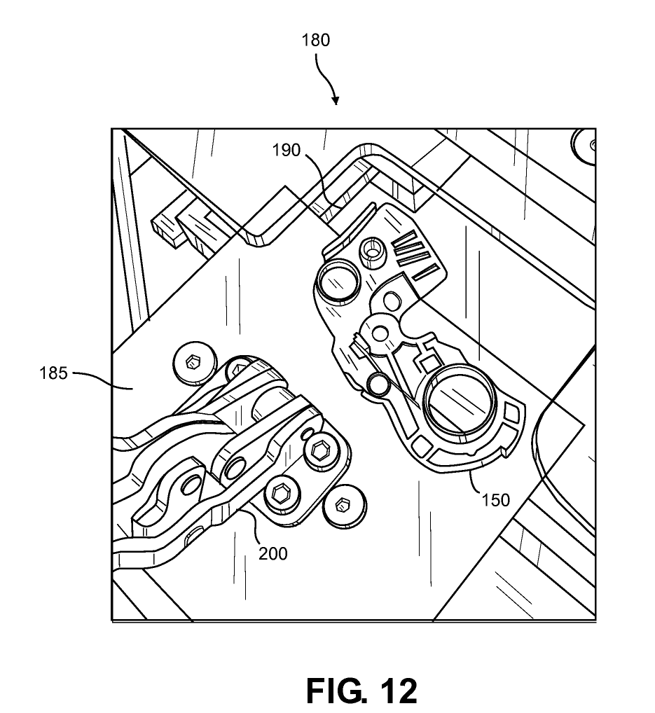

In one exemplary embodiment, a protrusion removal device 180 may be used to remove the activation tab 155 as shown in FIG. 11. The device 180 may comprise a holding platform 185 configured to accommodate the end cap 150 with the activation tab 155 facing down as shown in FIGS. 11-12. The device 180 may comprise a movable blade 190 configured to move from a resting position to a second position and back to the resting position along a direction shown by arrow 195. In one exemplary embodiment, the blade 190 may be moved by an air piston (not shown) that is activated by a switch (not shown).

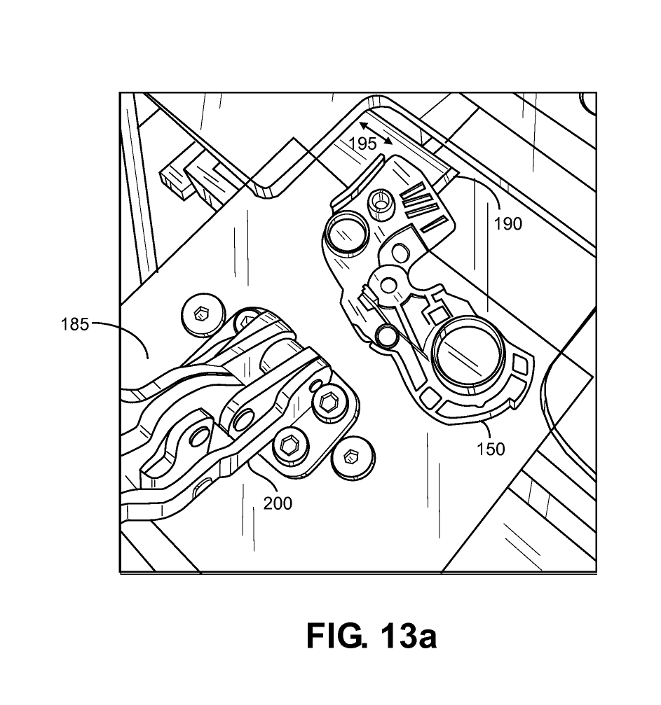

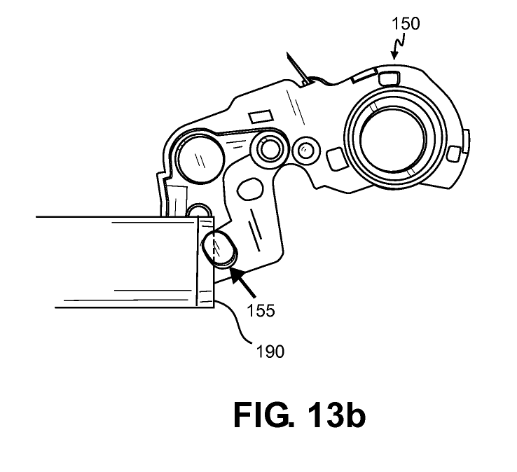

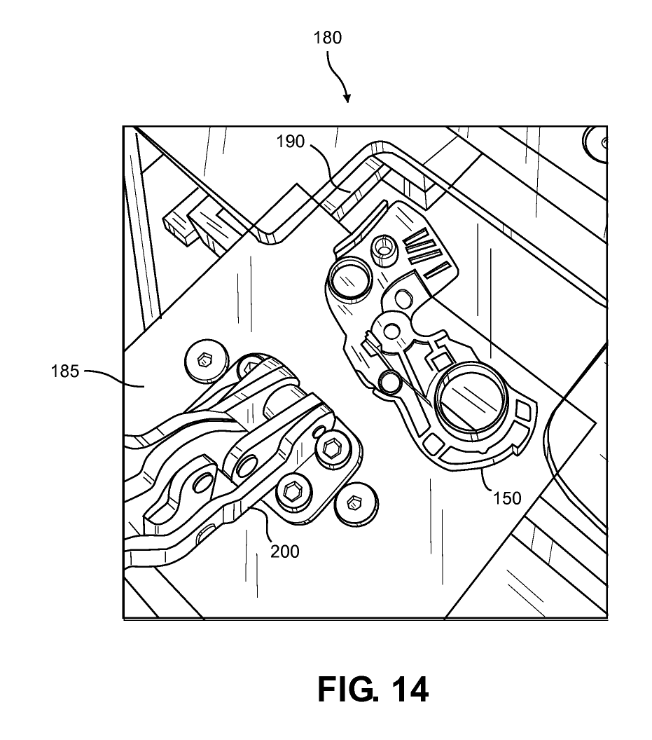

In one exemplary embodiment, the end cap 150 may be placed on the holding platform 185 with the activation tab 155 facing the blade 190 as shown in FIG. 12. Activating the air piston (not shown) may move the blade 190 from it resting position (shown in FIG. 12) to the second position (shown in FIG. 13a) in the direction shown by arrow 195 thereby removing at least a portion of the activation tab 155 from the end cap 150. FIG. 13b depicts the blade 190 as it removes the activation tab 155. The removed portion of the activation tab 155 may be allowed to fall into a holding compartment (not shown) located below the blade 190. The blade 190 may be allowed to return to its resting position after removing a portion of the activation tab as shown in FIG. 14.

In another exemplary embodiment, the blade 190 may remain in the stationary position and the end cap 150 may be moved from a resting position (not shown) to a secondary position (not shown) in the direction represented by arrow 195.

The device 180 may optionally comprise a holding arm 200 configured to hold the end cap 150 in place (not shown) during the removal of the activation tab 155.

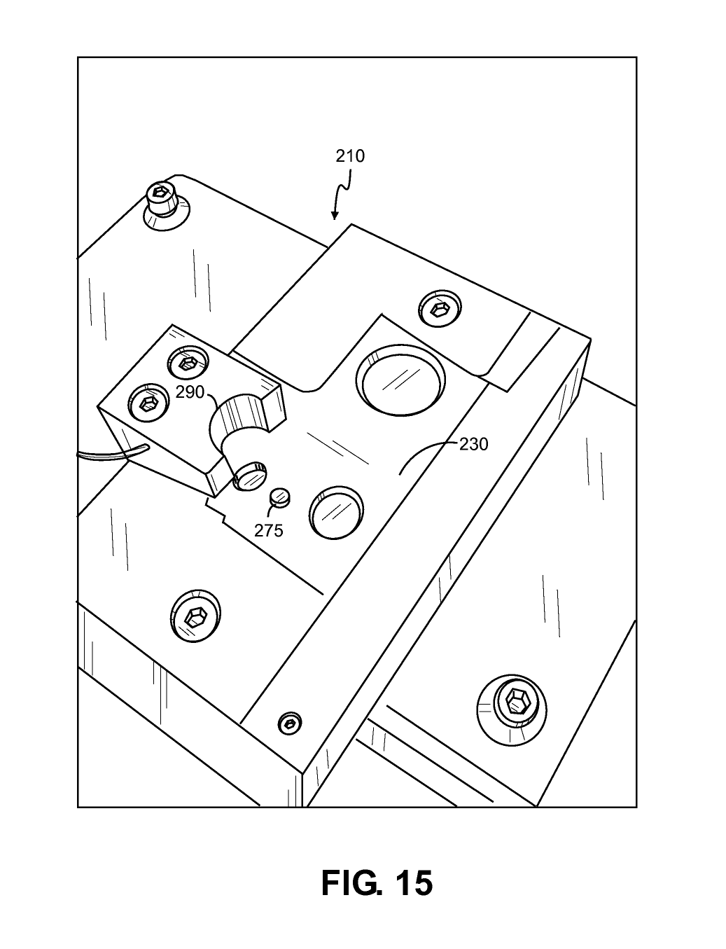

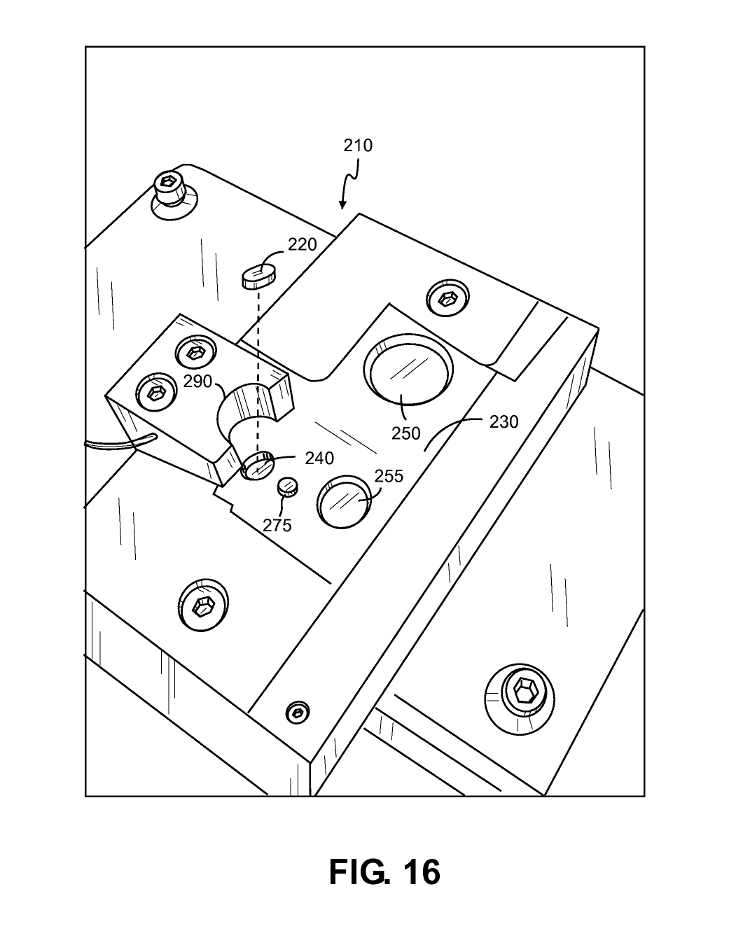

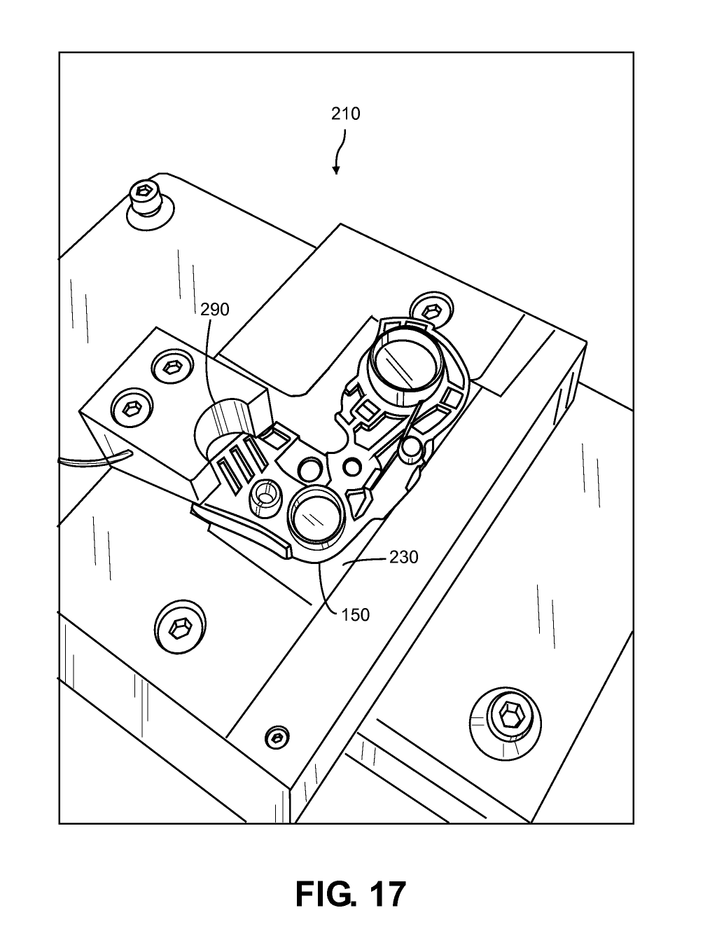

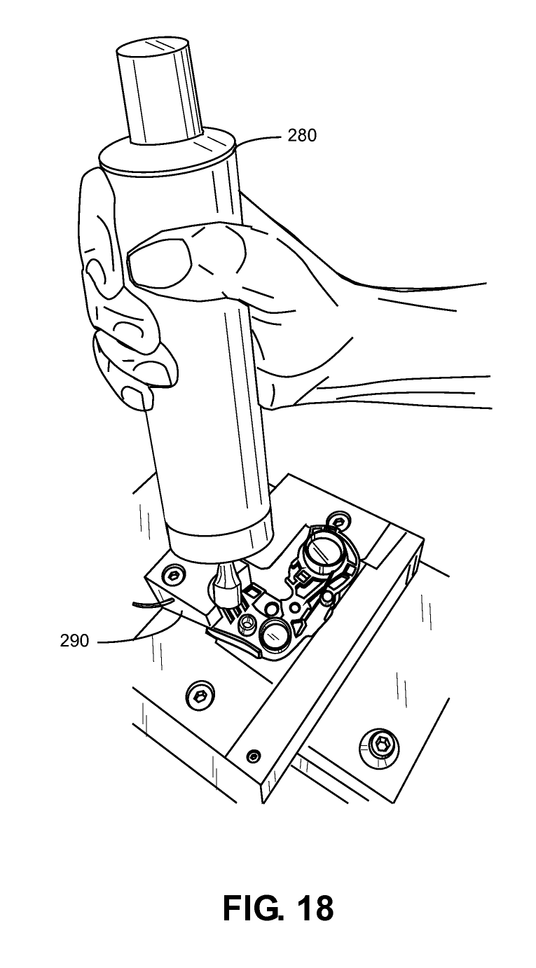

In an exemplary embodiment, an alignment platform 210 may be used to align a new or a pre-cut activation tab 220 at the proper position and/or angle with the end cap 150 as shown in FIGS. 15-16. The platform 210 may comprise a plate 230 configured to accommodate the end cap 150 as shown in FIG. 17. The plate 230 may define an opening 240 configured to accommodate the new or pre-cut activation tab 220 as shown in FIG. 16. Position of the opening 240 depends on where the new or pre-cut activation tab 220 should be provided on the end cap 150.

The plate 230 may optionally define one or more opening 250, 255 configured to accommodate one or more protrusions 260, 270 associated with the end cap 150. The plate 230 may optionally comprise a protrusion 275 configured to accommodate an opening 280 defined by the end cap 150.

In one exemplary embodiment, the new activation tab 220 may be ultrasonically welded to the end cap 150 using, for example an ultrasonic welding machine 280. The ultrasonic welding machine 280 may be used to transmit vibrations at an ultrasonic frequency and pressure large enough to fuse or weld together the new activation tab 220 and the end cap 150. In one exemplary embodiment, the new activation tab 220 may be welded to the end cap 150 using an automatic pneumatic ultrasonic machine (not shown).

The plate 230 may optionally comprise a guide 290 configured to guide the welding machine 280 to the welding location of the new activation tab 220 and the end cap 150.

In another exemplary embodiment, the new activation tab 220 may be glued to the end cap 150. In another exemplary embodiment, the new activation tab 220 may be coupled, or fastened by screw or other fastener to the end cap 150.

In one exemplary embodiment, the activation tab 220 is substantially same dimension as the activation tab 155. In another exemplary embodiment, the dimensions of the activation tab 220 are different from the dimensions of the activation tab 155.

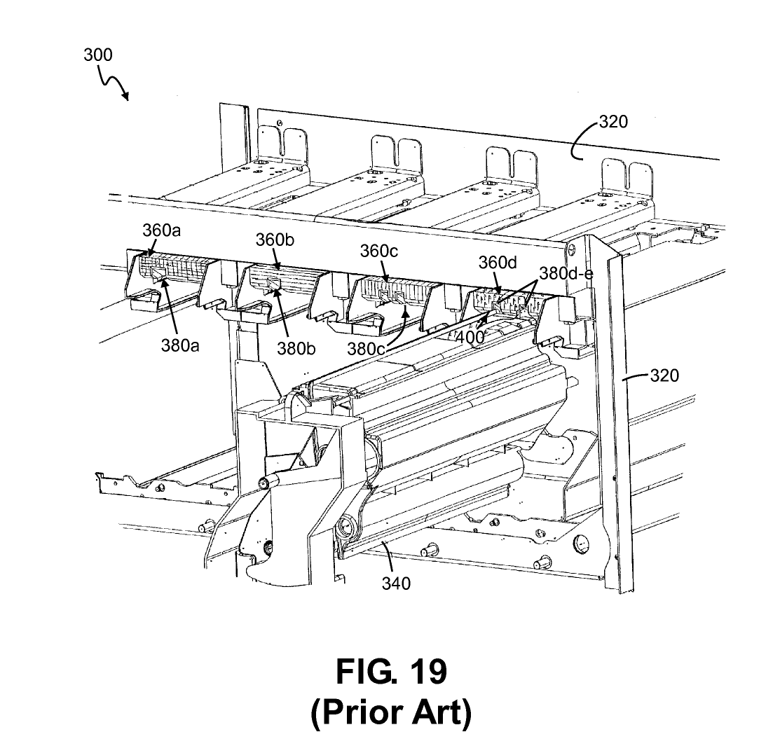

Referring to FIG. 19, as known in the art, color image forming apparatus 300 may comprise a frame 320 and a plurality of print cartridges 340 (one of which is shown for ease or reference). Each print cartridge 340 corresponds to a different color to be printed on the print medium. The frame 320 is configured to define a plurality of docking stations 360a-d, with each docking station 360a-d corresponding to different print cartridge 340. Each docking station 360a-d includes a mating keying feature 380a-d which only allows interconnection with a corresponding keyed print cartridge 340. More particularly, each mating keying feature 380a-d at each docking station 360a-d is in the form of at least one recess which is configured with a geometric and/or positional constraint relative to a keying feature of a correspondingly keyed print cartridge 340. Mating keying features 380a-d are shown in FIG. 19.

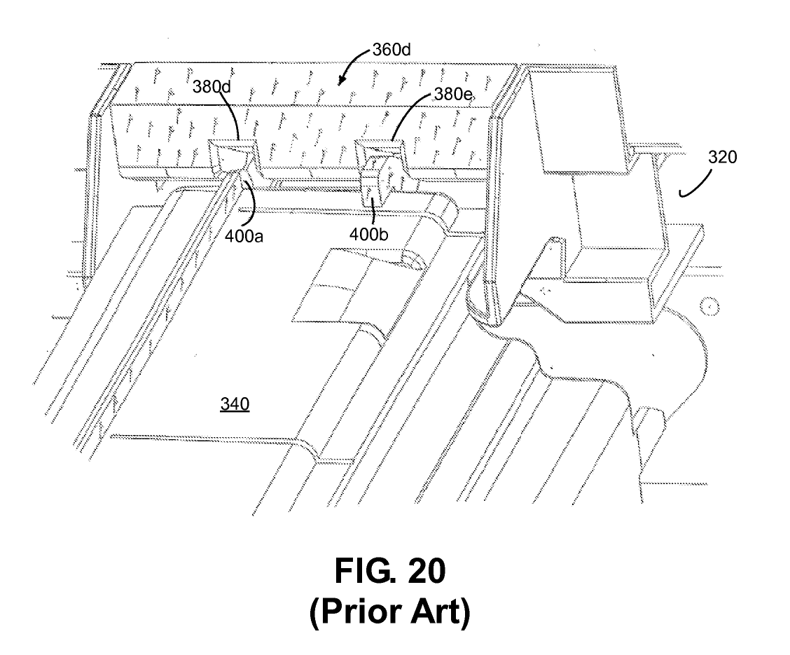

The print cartridge 340 includes keying features/protrusions 400a-b which are different from keying feature(s) of the remaining print cartridges (not shown), and mates with the mating keying feature 380d-e at the docking station 360d. More particularly, keying features 400a-b of the print cartridge 340 are in the form male tabs (as shown in FIG. 20) which fit into corresponding female recesses defining the mating keying features 380d-e.

During installation, the print cartridge 340 is aligned at the station 360d and slid in into the color image forming apparatus 300. Keying feature 400a-b in the form of the male tabs align with the mating keying features 380d-e in the form of the female recesses. Keying features/protrusions 400a-b thus fit within mating keying feature 380d-e at the station 360d. In the event that the different print cartridge with a different keying feature corresponding to a different color toner is attempted to be installed at the station 360d, the keying feature thereof defines a hard stop such that the print cartridge 340 cannot be installed at an improper docking station.

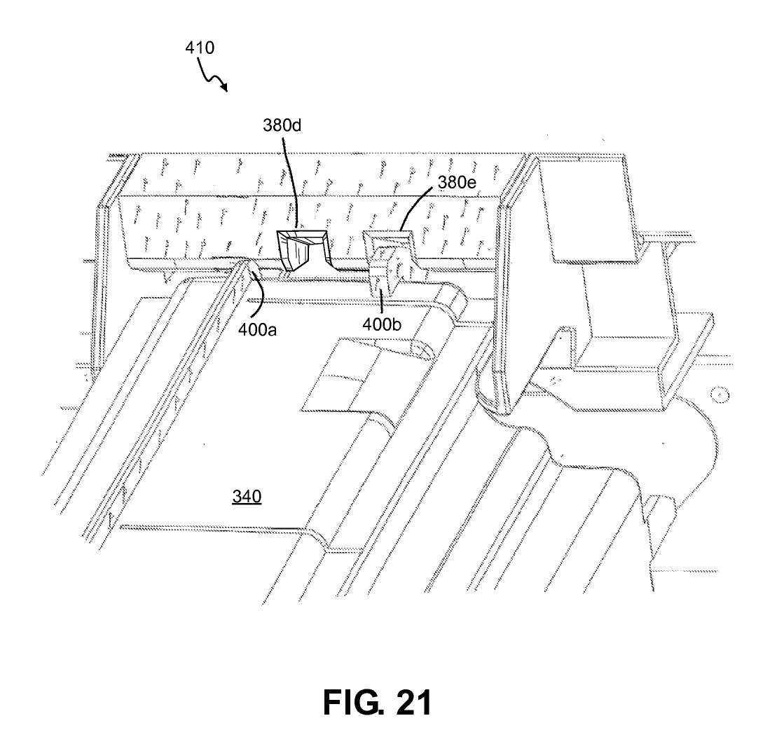

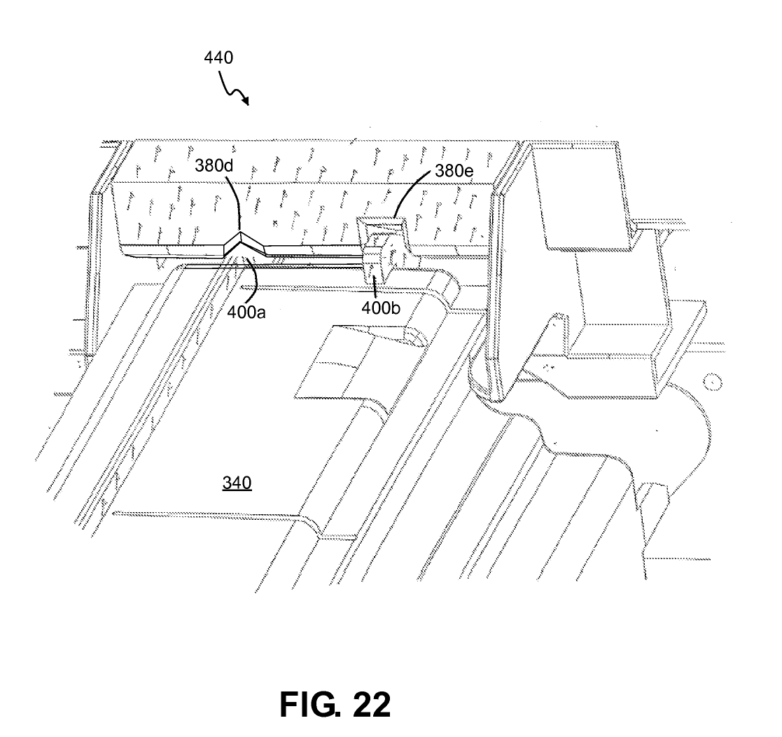

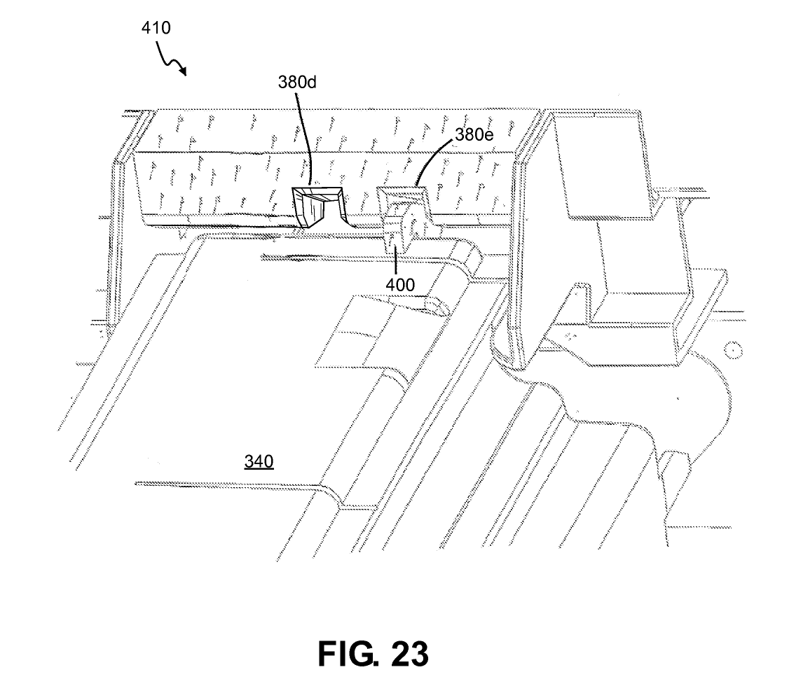

As the color image forming apparatus 300 is redesigned and/or changed into an image forming apparatus 410, 440 by the manufacturer, the female recessed of the keying feature 380d-e may be repositioned (as shown in FIGS. 21, 23) and/or have their shape changed (as shown in FIG. 22). When that occurs, the manufacturers of the toner cartridge may have to re-design the toner cartridges and/or the keying features/protrusions 400a to accommodate the new color image forming apparatus 410, 440.

In one exemplary embodiment according to the present disclosure, at least the protrusion 400a associated with the print cartridge 340 may be at least partially removed, replaced, and/or moved to another location to accommodate the changes in the image forming apparatus.

In one exemplary embodiment, the protrusion 400a may be removed to allow the print cartridge 340 to be inserted into the new color image forming apparatus 410 as shown in FIG. 23. In one exemplary embodiment, the removal of at least a portion of the protrusion 400 may create an opening (not shown) in the print cartridge 340. The opening may be covered using, for example, a tape and/or plastic sheet.

Different techniques may be applied to remove at least a portion of the protrusion 400a. In one exemplary embodiment, at least a portion of the protrusion 400a may be removed using a blade and/or a knife. In another exemplary embodiment, at least a portion of the protrusion 400a may be removed using pliers to break at least a portion of the protrusion 400a off the print cartridge 340. In another exemplary embodiment, at least a portion of the protrusion 400a may be removed using a saw, a laser and/or water-jet.

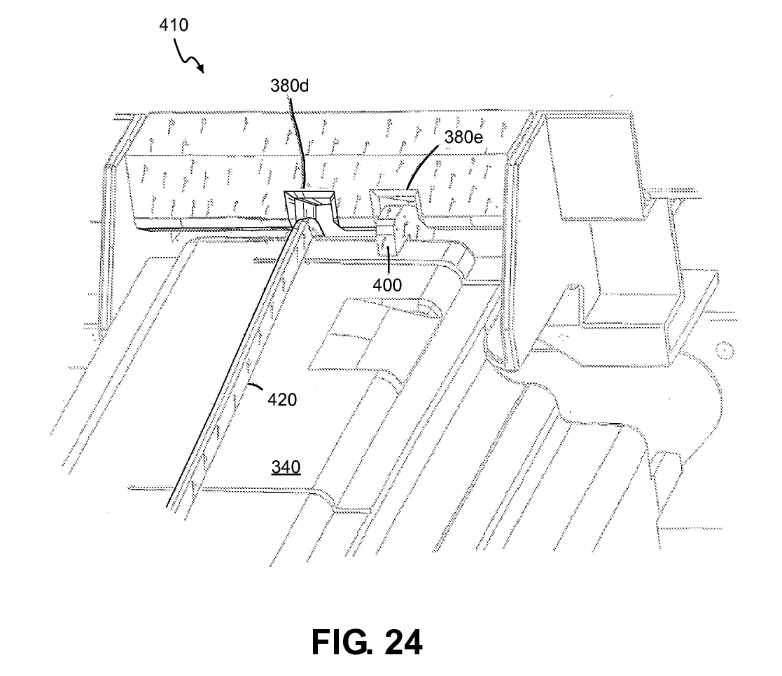

Although the print cartridge 340 will fit the new color image forming apparatus 410 once at least a portion of the protrusion 400a is removed, in one exemplary embodiment another protrusion 420 (shown in FIG. 24) may be provided to accommodate the keying feature 380d shown in FIGS. 21 and 23-24.

In one exemplary embodiment, the protrusion 420 may be glued, welded, coupled, fastened or fused to a portion of the print cartridge 340 and aligned with the keying feature 380d. Because the protrusion 420 is configured to accommodate the keying feature 380d, the print cartridge 340 may be prevented from being inserted into one of the other docking station 360a-c.

In an exemplary embodiment, the protrusion 420 may comprise different shape and/or dimensions from the removed protrusion 400a. In another exemplary embodiment, the protrusion 420 may comprise substantially same shape and/or dimensions as the removed protrusion 400a. In another exemplary embodiment, the removed protrusion 400a may be recycled and applied back to the print cartridge 340 as the protrusion 420.

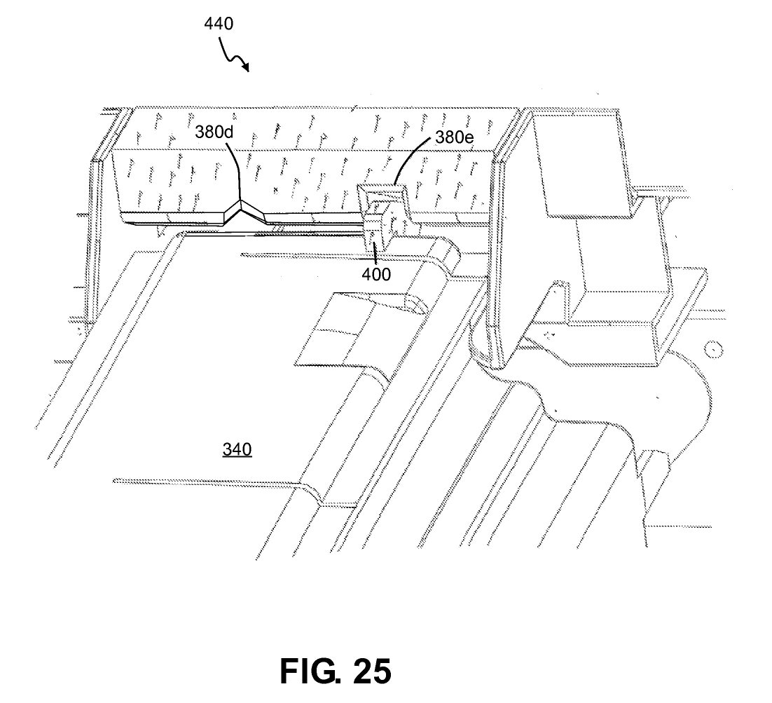

In an exemplary embodiment, the protrusion 400a may be removed to allow the print cartridge 340 to be inserted into the new color image forming apparatus 440 as shown in FIG. 25. In one exemplary embodiment, the removal of at least a portion of the protrusion 400a may create an opening (not shown) in the print cartridge 340. The opening may be covered using, for example, tape and/or plastic sheet.

Different techniques may be applied to remove at least protrusion 400a. In one exemplary embodiment, at least a portion of the protrusion 400a may be removed using a blade and/or a knife. In another exemplary embodiment, at least a portion of the protrusion 400a may be removed using pliers to break at least a portion of the protrusion 400a off the print cartridge 340. In another exemplary embodiment, at least a portion of the protrusion 400a may be removed using a saw, a laser and/or water-jet.

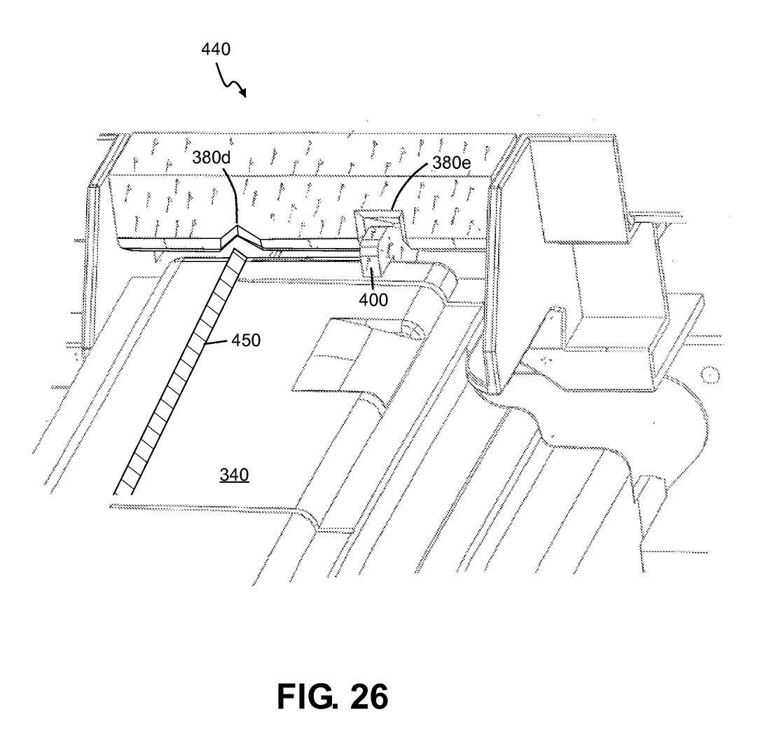

Although the print cartridge will fit the new color image forming apparatus 440 once the protrusion 400a is removed, in one exemplary embodiment another protrusion 450 (shown in FIG. 26) may be provided to accommodate the keying feature 380d shown in FIGS. 22 and 25-26.

In one exemplary embodiment, the one protrusion 450 may be glued, welded, coupled, fastened or fused to a portion of the print cartridge 340 and aligned with the keying feature 380d. Because the protrusion 450 is configured to accommodate the keying feature 380d, the print cartridge 340 may be prevented from being inserted into one of the other docking station 360a-c. In an exemplary embodiment, the protrusion 450 may comprise a shape configured to match the shape of the keying feature 380d.

Also, it is to be understood that the phraseology and terminology used herein is for the purpose of description and should not be regarded as limiting. The use of “including,” “comprising,” or “having” and variations thereof herein is meant to encompass the items listed thereafter and equivalents thereof as well as additional items. Unless limited otherwise, the terms “connected,” “coupled,” and “mounted,” and variations thereof herein are used broadly and encompass direct and indirect connections, couplings, and mountings. In addition, the terms “connected” and “coupled” and variations thereof are not restricted to physical or mechanical connections or couplings.

While several illustrative embodiments of the invention have been shown and described, numerous variations and alternative embodiments will occur to those skilled in the art. Such variations and alternative embodiments are contemplated, and can be made without departing from the scope of the invention as defined in the appended claims.

As used in this specification and the appended claims, the singular forms “a,” “an,” and “the” include plural referents unless the content clearly dictates otherwise. The term “plurality” includes two or more referents unless the content clearly dictates otherwise. Unless defined otherwise, all technical and scientific terms used herein have the same meaning as commonly understood by one of ordinary skill in the art to which the disclosure pertains.

The foregoing detailed description of exemplary and preferred embodiments is presented for purposes of illustration and disclosure in accordance with the requirements of the law. It is not intended to be exhaustive nor to limit the invention to the precise form(s) described, but only to enable others skilled in the art to understand how the invention may be suited for a particular use or implementation. The possibility of modifications and variations will be apparent to practitioners skilled in the art. No limitation is intended by the description of exemplary embodiments which may have included tolerances, feature dimensions, specific operating conditions, engineering specifications, or the like, and which may vary between implementations or with changes to the state of the art, and no limitation should be implied therefrom. Applicant has made this disclosure with respect to the current state of the art, but also contemplates advancements and that adaptations in the future may take into consideration of those advancements, namely in accordance with the then current state of the art. It is intended that the scope of the invention be defined by the Claims as written and equivalents as applicable. Reference to a claim element in the singular is not intended to mean “one and only one” unless explicitly so stated. Moreover, no element, component, nor method or process step in this disclosure is intended to be dedicated to the public regardless of whether the element, component, or step is explicitly recited in the claims. No claim element herein is to be construed under the provisions of 35 U.S.C. Sec. 112, sixth paragraph, unless the element is expressly recited using the phrase “means for . . . ” and no method or process step herein is to be construed under those provisions unless the step, or steps, are expressly recited using the phrase “step(s) for . . . .”

What is claimed is:

1. A method comprising:
providing a first portion of a housing comprising at least one protrusion;
removing at least a portion of the at least one protrusion; and
coupling a first material with a second portion of the housing.

2. The method of claim 1, wherein the at least one protrusion is a guide key, an activation key or a keying feature.

3. The method of claim 1, wherein removing at least a portion of the at least one protrusion comprises using a knife, a blade, a laser, a water-jet, pliers or a saw.

4. The method of claim 1, wherein coupling a first material with the housing comprises welding or gluing the first material with the housing.

5. The method of claim 1, wherein the first material is substantially similar to the at least one protrusion.

6. The method of claim 1, wherein the first portion of the housing is the second portion of the housing.

7. The method of claim 1, wherein the first portion of the housing is an end cap of a toner cartridge.

8. The method of claim 1, wherein the first portion of the housing is a first portion of a toner cartridge.

9. The method of claim 1, wherein the at least one protrusion comprises the first material.

10. A method comprising:
providing a housing for a toner cartridge configured to accommodate a first image forming apparatus;
removing at least a portion of the housing, and
coupling a first material with the housing to allow the toner cartridge to accommodate a second image forming apparatus.

11. The method of claim 10, wherein the least the portion of the housing is a protrusion, a guide key, an activation key or a keying feature.

12. The method of claim 10, wherein removing at least a portion of the housing comprises using a knife, a blade, a laser, a water-jet, pliers or a saw.

13. The method of claim 10, wherein coupling a first material with the housing comprises welding or gluing the first material with the housing.

14. The method of claim 10, wherein the first material is substantially similar to the at least the portion of the housing.

15. The method of claim 10, wherein the housing is an end cap of a toner cartridge.

16. A housing comprising:
a portion of a first protrusion configured to accommodate a first image forming apparatus; and
a second protrusion configured to accommodate a second image forming apparatus.
